(19) United States
(12) Patent Application Publication
(10) Pub. No.: US 2016/0239880 A1
(43) Pub. Date: Aug. 18, 2016

(54) WEB ADVERTISING PROTECTION SYSTEM

(71) Applicant: Pagefair Limited, Dublin (IE)

(72) Inventors: Sean BLANCHFIELD, Dublin (IE); Brian McDONNELL, Newbridge (IE); Neil O'CONNOR, Ashbourne (IE); Miles McGUIRE, Dublin (IE)

(73) Assignee: Pagefair Limited, Dublin (IE)

(21) Appl. No.: 15/044,653

(22) Filed: Feb. 16, 2016

Related U.S. Application Data
(60) Provisional application No. 62/117,005, filed on Feb. 17, 2015.

(51) Int. Cl. G06Q 30/02; H04L 29/08; G06F 3/0484; G06F 17/22; G06F 17/21; G06F 9/44; G06F 17/27

(52) U.S. Cl. CPC G06Q 30/0277; G06F 8/30; H04L 67/02; G06F 17/272; G06F 17/2288; G06F 17/2247; G06F 17/2252; G06F 17/211; G06F 3/04842

(57) ABSTRACT

A method and associated system removes identifiable attributes from displayed advertising content, and instead locates these attributes within the isolated memory area that is accessible only the embedded Javascript™. Steps are taken to ensure that the displayed advertising content is correctly formatted, and Javascript™ routines are used to emulate the normal interactive functionality of the ad. Because the identifiable attributes of the ad content are now located in the isolated world of the embedded Javascript™, it is not possible for a web browser plugin executing in isolated world to access them. In this way, it becomes impossible for an ad blocking tool to automatically identify and remove such advertising content.

### RELATED APPLICATION

The present application relates to and claims the benefit of priority to U.S. Provisional Patent Application No. 62/117005 filed 17 Feb. 2015 which is hereby incorporated by reference in its entirety for all purposes as if fully set forth herein.

### BACKGROUND OF THE INVENTION

1. Field

The present invention relates in general to methods by which advertisements are included web pages, and more particularly to methods to ensure that the correct display of such advertisements cannot be subverted by external software.

2. Relevant Background

The most highly visited websites in the world make money through the display of advertising on behalf of other businesses. The global online advertising market was forecast to amount to $121 billion US dollars in 2014. This advertising expenditure permits websites to provide their services free of charge to consumers.

In recent years, a number of software tools have emerged that automatically prevent the display of advertising content. An exemplar is the “AdBlock” extension, which is used by millions of web users. These ad blocking tools augment the behavior of the web browser, automatically modifying web pages to prevent advertising from either loading or being displayed. These tools act unilaterally on all forms of advertising, so that although a user may intend only to block certain inconvenient forms of advertising, other kinds of advertising are also blocked by default without explicit user consent. By tampering with the intended user experience, these tools damage to the business model of the companies that provide the ad-funded content that these users enjoy. The continued existence of these businesses depends upon the correct display of their intended advertising alongside the content they produce.

It would therefore be advantageous to have a system whereby website publishers can ensure that the intended advertising cannot be automatically removed by ad blocking tools. The present teachings disclose such a system and method to prevent advertising that is embedded in web page from being automatically removed using prior knowledge of their attributes or functionality.

It is necessary to first outline the conventional system and method by which advertisements are displayed on web pages. A conventional method by which advertisements are displayed is described with reference to FIG. 1, FIG. 2 and FIG. 3. Referring to FIG. 1, a web browser 103 requests a web page (107) from a web server 101, and receives in response a HTML document (108). The web browser then displays the web page on-screen by interpreting and performing instructions contained in a HTML document.

Web pages consist of a mixture of text and other elements, such as images, video and interactive components. As would be evident to a skilled person in the art, an “element” refers to any one of a number of standard HTML components that may exist in a HTML document, each of which may have any number of additional specified attributes, as set out in the HTML standard.

In the illustrated example of FIG. 1, the web page contains two advertising elements 104 and 105, as well as non-advertising content element 106. It is normal for it to be arranged so that advertising elements such as 104 and 105 reference a relevant advertiser server 102 via links 109 and 110 respectively, so that if a user wishes to learn more about in the advertising content, he or she can click on it to visit the advertiser web page.

The structure of a HTML document is best described with reference to FIG. 2. The document consists of a tree-like structure of elements. Starting with a parent element 201, each element contains an ordered list of other elements, each of which may contain yet more elements. It is usual for the parent element 201 to contain two sub-elements: a “head” element 202 and a “body” element 211. Sub-elements of 202 normally contain instructions to the web browser about web page formatting or behavior, whereas sub-elements of the “body” element 211 contain the visible content of the web page. In FIG. 2, the sub-elements 204 and 205 may be considered equivalent to the visible advertising elements of the web page 104 and 105 depicted in FIG. 1. Likewise, the sub-element 206 is equivalent to the main content element 106 of FIG. 1. Each of these sub-elements may themselves contain any number of further sub-elements.

A detailed illustration of the layout of a typical advertising element is provided in FIG. 3. With reference to FIG. 3, the element 305 can be considered to correspond to the element 205 of FIG. 2, and there is likewise element 212 corresponds to element 312. As can be seen from the figure, HTML elements are rendered in the web page layout with a rectangular shape. In addition, sub-elements are rendered in a rectangular sub-region of their parent elements. Elements such as 305 may possess certain explicit attributes 320 and 321, which can be used to identify the element among the other elements in the HTML document. Some elements, such as element 312, may possess attributes such as “href” 321, which instruct the web browser to respond to any click upon the element 312 or its sub-elements by loading a specified web page URL. The element 312 also contains content 314, which is not a sub-element, but is text that will be rendered within the region of 314 by the web browser. These elements and sub-elements may possess a multitude of additional attributes that support additional functionality or formatting.

The layout and formatting of the text and other elements are performed according to instructions specified in the HTML document. This may be achieved through direct instructions in the HTML document, or by indirect instructions contained in files that the HTML document refers to.

Such instructions are normally specified by use of Cascading Style Sheets, or “CSS”. CSS is a computer language to control the visual display of information contained in HTML documents. Any number of CSS instructions can be supplied to the browser, either directly within a “style” element 203 in the HTML document or in separate documents that are referenced by such a “style” element 203. The parts of a CSS document such as 203 are best understood with reference to FIG. 4. In FIG. 4, the style element 403 can be considered equivalent to 203 from FIG. 2. The style element contains CSS code, which is divided into a number of CSS instructions, such as 421 and 431. Each CSS instruction provides a selector that identifies what elements in the HTML document it should be applied to. Instruction 421 provides the selector 422, which means that the instruction will be applied to HTML documents that have attributes that match the contents of the selector. Each CSS instruction also provides a number of rules, such as 423 and 424, which govern how the content is displayed, for example the size, color and alignment of text contained within elements of the HTML matched by the selector.

Ad blocking tools, such as those provided in the form of plugin programs, identify elements of HTML documents that are known to contain advertising content, such as elements 204 or 205. It may identify these advertising elements by inspecting the values of the attributes they possess, such as attributes 320, 321 and 320. Once the ad blocking plugin has identified these elements, it can reformat the HTML document so as to render them invisible. Such elements can be made invisible either by configuring new CSS instructions, or by deleting them from the HTML document.

In a conventional arrangement, the computer code of an ad blocking tool executes within a modern web browser, in contrast to the execution of code that is embedded within HTML documents to provide interactive functionality. This is best considered with reference to FIG. 5, in which the web browser 501 contains within its memory various components such a number of distinct HTML documents such as 502, and a number of plugin programs such as 506 and 507.

Modern web browsers, such as Google Chrome and Mozilla Firefox support the execution of Javascript™ code or other executable codes, which can be embedded in HTML “script” elements such as 208 to provide additional functionality. With reference to FIG. 5, each HTML document 502 may in this way have its own embedded Javascript™ programs, such as the embedded Javascript™ program 503. In addition, the web browsers support browser plugins 506 and 507, which are third party software programs that can be embedded in the web browser, as opposed to any individual web page. Browser plugins normally consist of Javascript™ code, but may be implemented in alternative language also. When a modern web browser loads a HTML document, it executes both the Javascript™ programs embedded in the document 503, and the code contained in any web browser plugins (506 and 507). The embedded Javascript™ program 503 has access only to the document 502 that it is embedded in, but plugin Javascript™ programs have access to all HTML documents. Such code thus has an opportunity to inspect, respond to, and modify HTML documents. It is through this mechanism that ad blocking tools are able to identify and make invisible any identifiable advertising elements in the HTML document.

It is also possible for Javascript™ code in embedded programs and plugin programs to react to specific events within the HTML document. A number of well-known types of interaction events can occur to any element such as 312, included but not limited to the user clicking upon the element. Any number of Javascript™ routines can be registered to respond to each such interaction event type that may occur to a given HTML element.

The ubiquitous popularity of embedded Javascript™ and browser plugins has raised issues of security and stability, which modern browsers have sought to address. By executing multiple Javascript™ programs during the normal course of processing a HTML document, a web browser opens up the possibility of unintentional side effects between Javascript™ programs. Without undue care, the Javascript™ embedded in a HTML document will share the same computer memory as the Javascript™ in a browser plugin, and therefore may unintentionally overwrite areas of the plugin's memory, and thus cause instability. A second concern is that browser plugins often have permission to perform actions that are normally not permitted to embedded Javascript™ plugins. For example, a web browser plugin may have permission to read the contents of files on the user's hard drive. A Javascript™ program embedded in a HTML document could deliberately interfere with the memory of browser plugin so as to cause it to perform operations that an embedded Javascript™ program would not normally have permission to perform. To address this security issue, as well as the general issue of instability caused by unintentional interference between embedded Javascript™ programs and plugin Javascript™ programs, modern web browsers have implemented an architecture known as “isolated worlds”.

The “isolated worlds” web browser architecture is best explained with reference to FIG. 6. In this system the memory of the embedded Javascript™ programs is separated from the memory of the plugin Javascript™ programs, while simultaneously providing both with access to the HTML document that they exist to operate upon.

With reference to FIG. 6, the area 601 represents the entire memory of the web browser. The web browser memory 601 contains the memory area representing the HTML document 601, which is equivalent to the HTML document 201. Also contained within the web browser memory 601 is the memory area reserved for use by embedded Javascript™ programs 603 and the memory area reserved for use by plugin Javascript™ programs 604.

In the isolated worlds architecture the memory areas 603 and 604 are separate from each other, so that code executing in one memory area is unable to access the memory of the other. In this way, it is not possible for a careless or malicious embedded Javascript™ program in area 603 to interfere with the memory of a plugin Javascript™ program executing in memory area 604.

Although the memory of embedded Javascript™ programs and browser plugins are fully isolated, they also require mutual access to the HTML document in order to be useful. Without further steps, mutual access to the same HTML document could become a point of interference. For example, embedded programs and plugin programs could overwrite routines that they have registered upon HTML elements to respond to interaction events. To prevent this situation, the web browser introduces and maintains the proxies 605 and 606, to replace direct access to the browser's HTML document 602. When a Javascript™ program in memory space 603 modifies the proxy 605, the HTML document 602 is consequently updated in a likewise fashion. In addition, the proxy 606 is also automatically updated to reflect the change. This mechanism also operates in reverse, so that changes to proxy 606 are reflected in the HTML document, and then in the proxy 605. The web browser also arranges for events that occur in the HTML document 602 or the proxies 605 or 606 to be communicated between all three versions.

By maintaining the separate proxies 605 and 606, the web browser makes it possible for both plugin Javascript™ programs and embedded Javascript™ programs to respond to interaction events in the HTML document, without any possibility of interfering with each other's memory. Previously, Javascript™ routines that were registered to respond to interaction events in the HTML document 602 would invariably do so in the shared memory of 601. However, with the isolated worlds architecture, such routines are registered to react to events in the proxies 605 and 606 instead of the HTML document 602, and therefore execute within the appropriate isolated memory area of 603 or 604. In this way, routines that respond to events in the HTML document do so in an isolated fashion, incapable of affecting or overwriting each other's functionality.

### SUMMARY OF THE INVENTION

Based on an understanding of the implementation of an “isolated world” architecture in the context of a modern browser, the present invention provides a method to prevent browser plugin code from modifying areas of the HTML document that embedded Javascript™ wishes to protect.

An example of the usefulness of this understanding is in the context of Ad Blocking. Ad blocking tools frequently rely on their ability to identify well-known attributes of HTML elements that contain advertising content. For example, such elements may have descriptive names, or possess attributes containing the names of advertiser servers that should be contacted if the user clicks upon the ad. If these identifying attributes are removed, ad blocking tools cannot automatically identify the advertising content, and therefore cannot alter the HTML document to cause them to be hidden. However there is no method in the art that makes it possible to remove identifiable attributes without also removing essential functionality or formatting of the advertisement. The inventors have found a method to remove these identifiable attributes without affecting the formatting or functionality of the advertising element.

The present teaching provides a method and system that removes identifiable attributes from displayed advertising content, and instead locates these attributes within the isolated memory area 603 that is accessible only the embedded Javascript™. Steps are taken to ensure that the displayed advertising content is correctly formatted, and Javascript™ routines are used to emulate the normal interactive functionality of the ad (such as ensuring that the act of clicking on an ad causes the web browser to visit the advertiser's web site). Because the identifiable attributes of the ad content are now located in the isolated world 603 of the embedded Javascript™, it is not possible for a web browser plugin executing in isolated world 604 to access them. In this way, it becomes impossible for an ad blocking tool to automatically identify and remove such advertising content.

### BRIEF DESCRIPTION OF THE DRAWINGS

The present application will now be described with reference to the accompanying drawings in which:

FIG. 1 is a diagram depicting the interaction between components of a conventional system by which web content and advertising is delivered to a web browser;

FIG. 2 is a diagram depicting the structure of a HTML document;

FIG. 3 is a diagram depicting the layout of an advertising element in a HTML document, including the attributes possessed by each contained element;

FIG. 4 is a block diagram depicting the components of a CSS document;

FIG. 5 is a block diagram depicting the main features of a web browser's memory, including multiple web pages and browser plugins.

FIG. 6 is a block diagram depicting the key components of the isolated worlds memory architecture of a modern web browser;

FIG. 7 is a block diagram depicting the key components of a protection engine system within an isolated worlds architecture in accordance with the present teaching;

FIG. 8 is a flowchart describing processing stages associated with a protection engine provided in accordance with the present teaching;

FIG. 9 is a diagram depicting the layout of an advertising element that has been recovered by the ad protection engine;

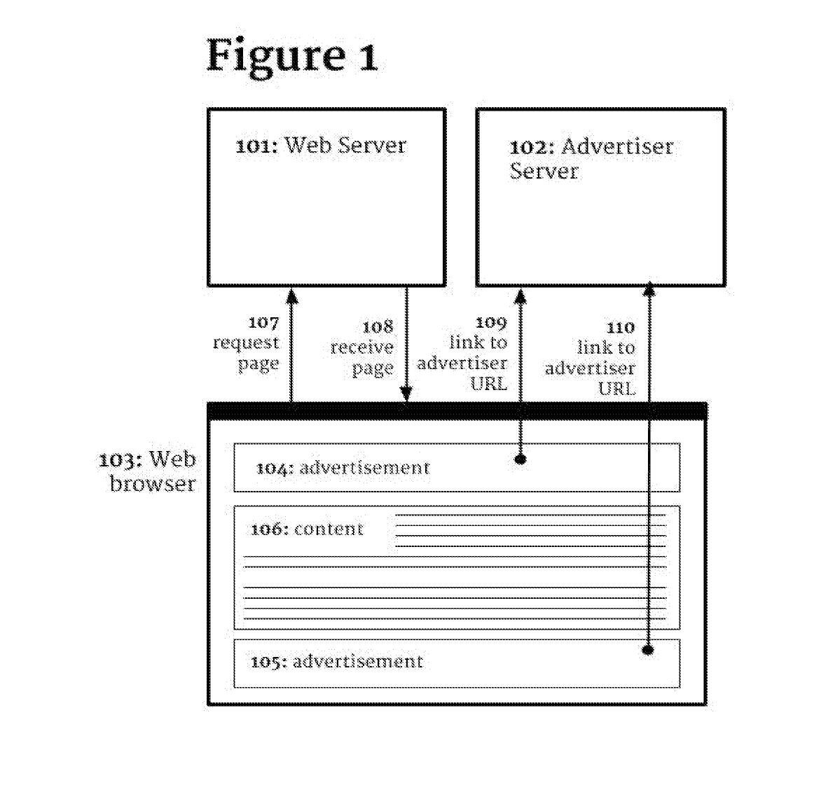

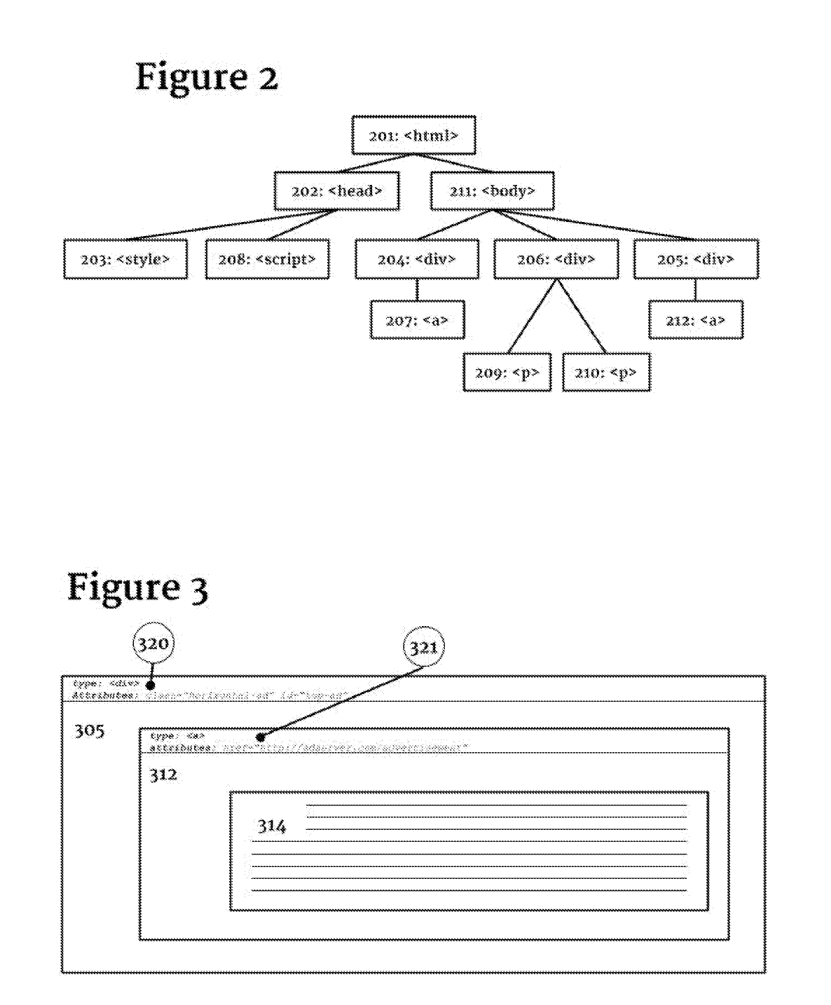

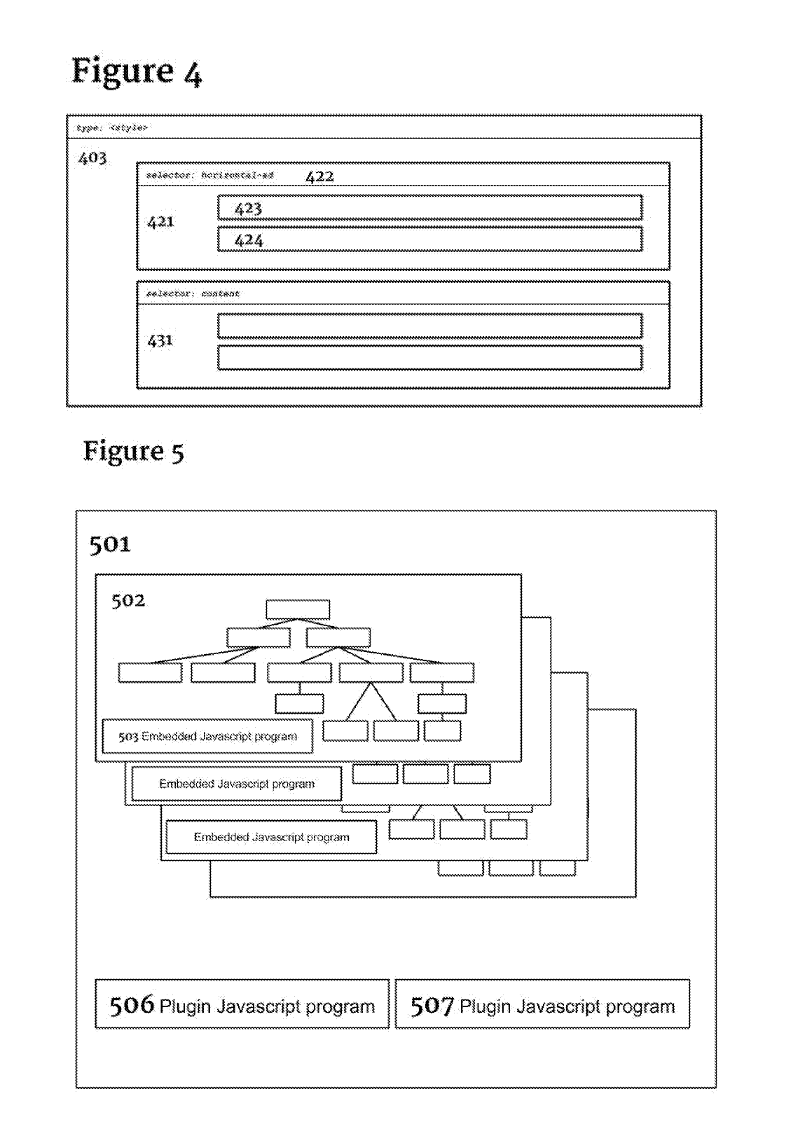

### DETAILED DESCRIPTION

Exemplary arrangements of a method and system provided in accordance with the present teaching will be described hereinafter to assist with an understanding of the benefits of the present teaching. Such a method and system may be understood as being exemplary of the types of methods and systems that could be provided and are not intended to limit the present teaching to any one specific arrangement as modifications could be made to that described herein without departing from the scope of the present teaching.

The present teaching provides a method and system to prevent advertising images on web pages from being automatically removed using prior knowledge of their attributes.

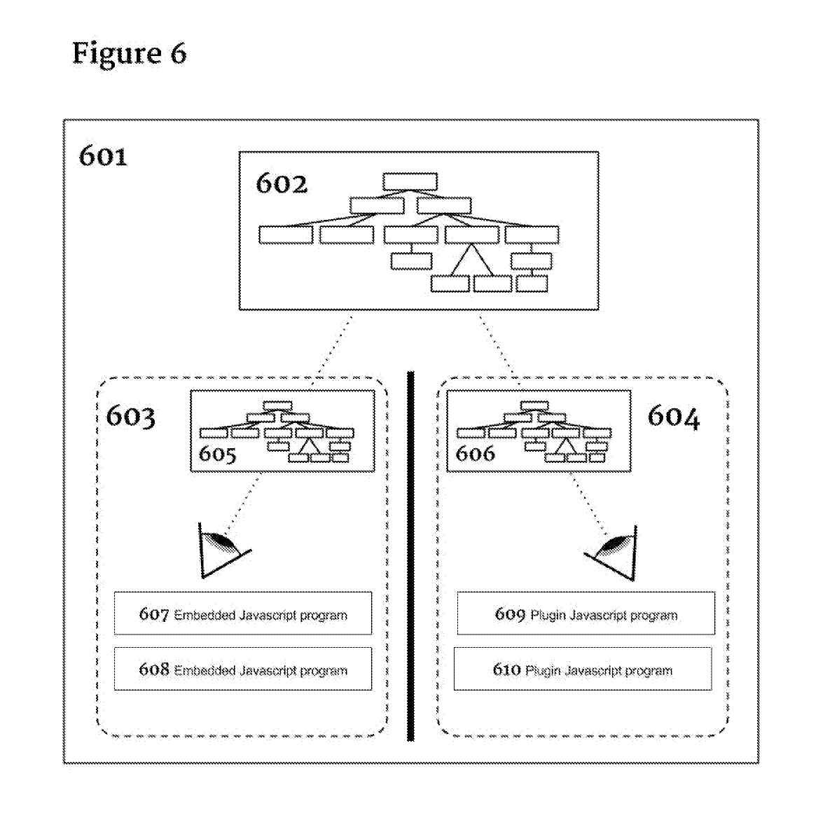

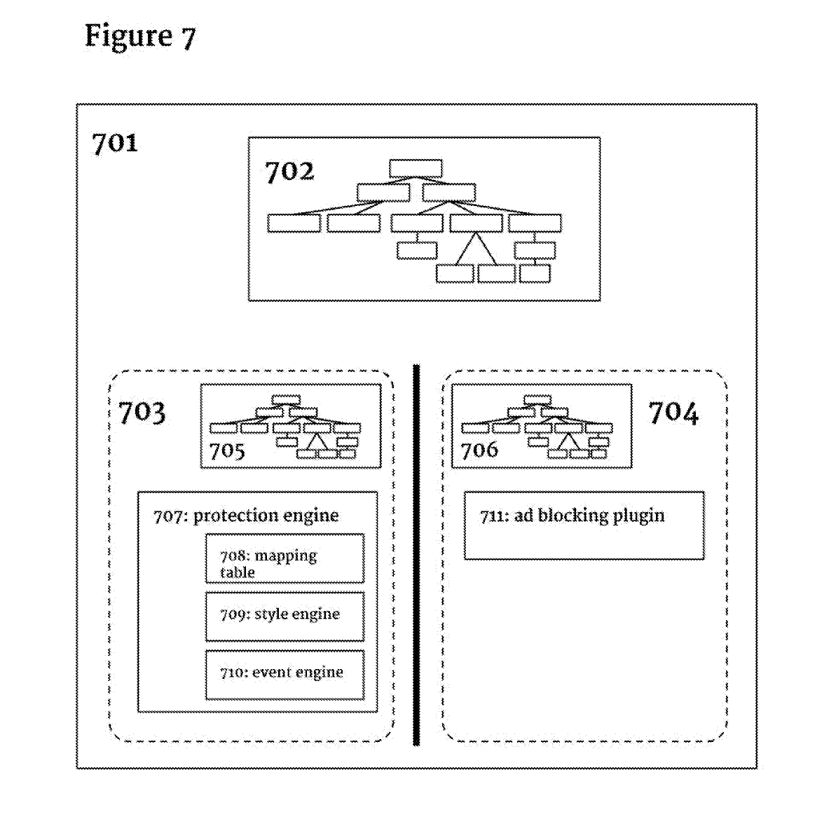

The teachings of the present application require the introduction of new components to the conventional system described in FIG. 7. FIG. 7 supplements FIG. 6 by illustrating new components of a system that permits advertising content to be inserted into a HTML document in such a manner that an ad blocking tool cannot identify it. In comparing FIG. 7 to FIG. 6, the browser memory 701 corresponds to the browser memory 601, the HTML document 702 corresponds to the HTML document 602, and the isolated worlds 703 and 704 correspond to the isolated worlds 603 and 604 respectively. Referring to FIG. 7, the components of the system include the mapping table 708, a style engine 709 and the event engine 710. The functionality of the each of these components may be integrated into one component termed the protection engine 707.

In one embodiment the ad protection engine may be operated in such a way as to respond to the event of ads being hidden by ad blocking tools, and in so doing to recover them. In another embodiment it may also be caused to preventatively process all advertising content so as to render them impervious to ad blocking tools. In this latter embodiment, aspects of the method described herein may be optionally executed upon the server instead of on the client web browser, however the method remains the same regardless of its place of execution.

The embodiment in which the ad protection engine reacts to the event of original advertising content being blocked is now described, as it provides the most complete illustration of the functionality of the invention.

When the web page is fully loaded, the ad blocking plugin 711 inspects the HTML document 706 to identify any elements that are recognizable as advertising elements. It can identify an element such as element 311 by virtue it its attributes, or the attributes of child elements. For example, it may recognize that the element 311 has a name given by its “class” and “id” attributes that indicate that it contains advertiser content. Alternatively, it may recognize that its child element 312 has an “HREF” attribute 321 that directs the browser to load a page from an advertiser server should it or any of its contained elements be clicked on. The ad blocking plugin may use any of a number of similar strategies to identify elements of the page that contain advertiser content.

The ad blocking plugin 711 then reformats the HTML document 706 to remove the advertising elements of the web page 104 and 105 (and equivalently 204, 205 and 305) from the displayed page. Due to the isolated world architecture implemented by the web browser causes these changes to be reflected in the web browser's HTML document 702 and subsequently into the embedded Javascript™ proxy 705.

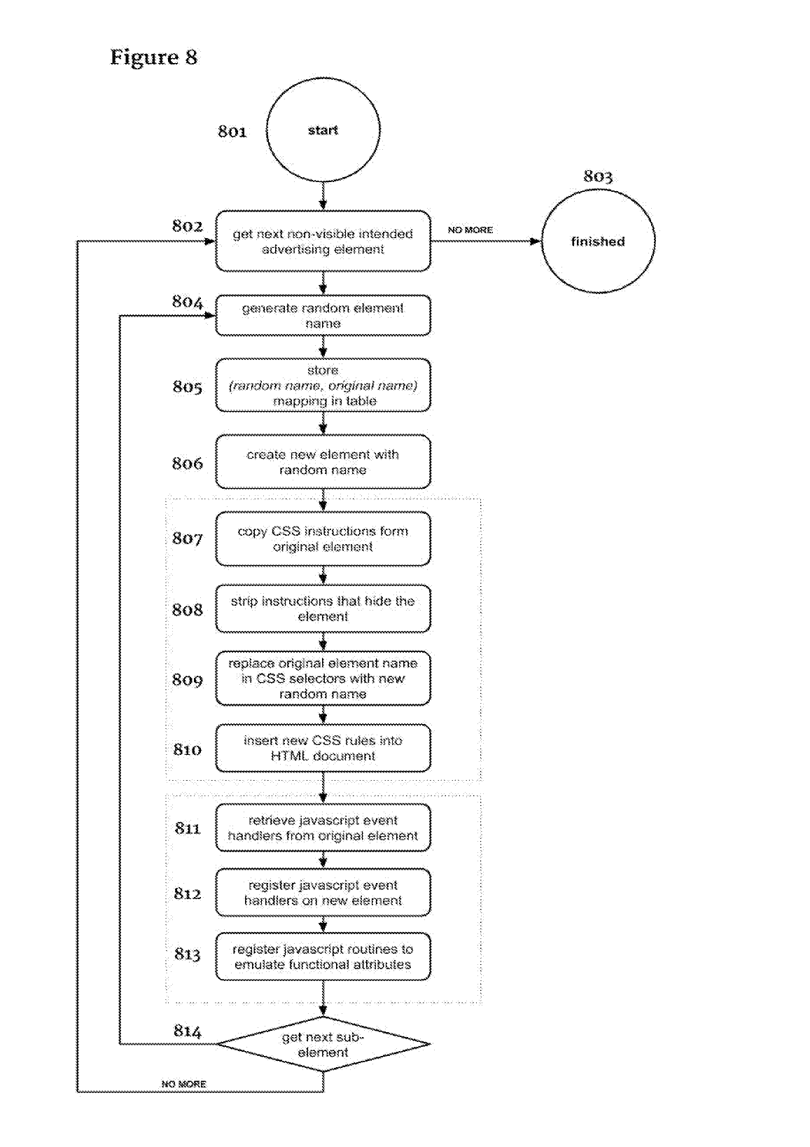

The steps now performed by the advertising protection engine 707 are best understood with reference to the flowchart illustrated in FIG. 8. In FIG. 8, the style engine 709 performs the steps 807-810, and the event engine 710 performs the steps 811-813. The advertising protection engine 707 begins (step 801) by scanning the HTML document 705 to find an intended advertising element that is no longer visible (step 802). If all intended advertising elements are visible in the document, then the ad protection engine concludes that there is no ad blocking plugin in effect and ceases operation (step 803).

In another embodiment, the ad protection engine will scan the HTML document for intended advertising elements, and if they are not present will conclude that the ad blocking plugin has removed them from the HTML document, as opposed to merely affecting their display. In this case, the ad protection engine would retrieve a backup copy of the intended advertising content in conjunction with the web server 101, and then proceed from step 804.

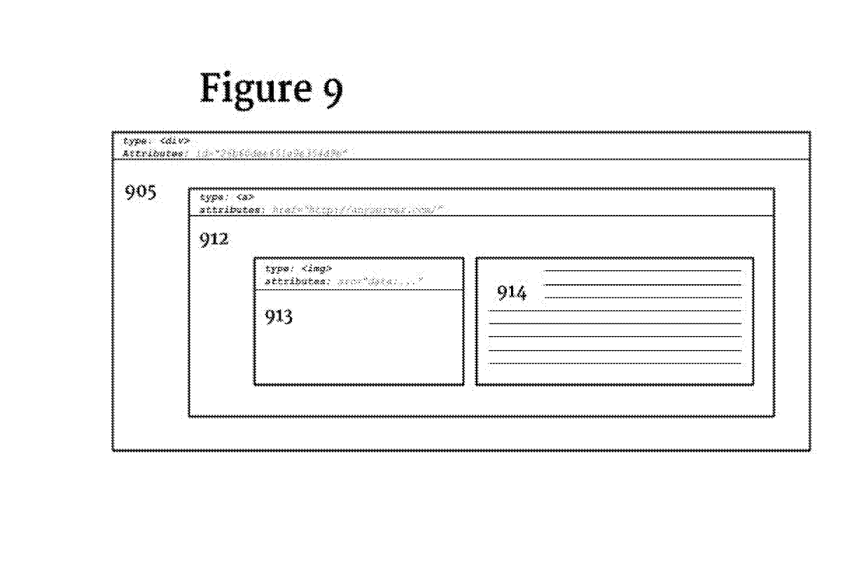

The ad protection engine 707 now identifies an intended advertising element 305 that is no longer visible (step 802). It next creates a new random name (step 804) and stores it in the mapping table 708 (step 805). The next steps are best understood with reference to FIG. 9, which illustrates a new HTML element that the protection engine 707 will create to contain the protected ad element. The ad protection engine creates a new HTML element 905 in the HTML document 705 and sets upon it an attribute with the value of the random name (step 806). Because this random name is the only identifiable attribute of element 905, and the only association between the random name and the advertising content is stored within the mapping table 708 within isolated world 702, the ad blocking plugin 711 remains unable to identify it as advertising content.

The style engine 709 now retrieves all CSS instructions that were applied to the original ad element 305 and makes a copy (step 807). From this copy it removes any instructions that could prevent an element they were applied to from correctly displaying, as such instructions may have originated from an ad blocking plugin (step 808). The style engine 709 now modifies the selectors referenced in the CSS instructions so that they refer to the random name of element 905 instead of to the original attributes of the original ad element 305 (step 809). The style engine now causes the new CSS rules to be added to the HTML document 705 (step 810), so that the formatting of the element 905 is made to match that of element 305.

The event engine 710 now performs steps to ensure that the element 905 has an equivalent behavior to the original element 305. This involves replacing Javascript™ routines that were registered to respond to events on the element 305 as well as registering new Javascript™ routines to emulate the functionality of the attributes of element 305. The event engine 710 first retrieves all Javascript™ routines registered to respond to events on element 305 (step 811), and registers these same routines (or copies of these routines) to respond to events on element 905 instead (step 812).

In another embodiment, the event engine 710 may not directly register the original routines on element 905, but instead register new event routines that act to emulate the event to the original element 305, which may be identified via consultation with the mapping table 708. For example, if the user clicks upon element 905, the associated event will be handled by a Javascript™ routine that will cause a click event to occur on element 305. Although the element 305 is not visible, any Javascript™ routines registered to it will still be present and capable of handling the event normally.

The event engine 710 next checks for the presence of attributes on element 305 that provide functionality, and registers new Javascript™ routines on element 905 that emulate the functionality of these original attributes (step 813).

The most common such functional attribute is the “HREF” (hyper-reference) attribute, which causes the web browser to load a specific web page whenever the element upon which it is set is clicked. In the context of online advertising, the HREF attribute is commonly used to permit users to click on ads that interest them, so that they can visit the advertiser's web page. HREF attributes that contain the names of known advertiser web servers are a powerful method by which ad blocking plugins can identify advertising content in a web page. By emulating the functionality of the HREF attribute from a Javascript™ routine, we make it impossible for the ad blocking plugin to identify the advertising content in the normal way. Furthermore, since the Javascript™ routine is contained within the embedded Javascript™ isolated world 703, there is no way for an ad blocking plugin in the isolated world 704 to inspect it. Thus, an important method by which ad blocking plugins operate is prevented. Likewise, any other functional attribute that specifies interactive behavior can be emulated in Javascript™ routines while remaining protected from ad blocking plugins.

Next, the advertising protection engine moves onto the next sub-element of the original advertising element 305, in this instance element 312 (step 814). It returns to step 804 and repeats the same process to create element 912 as a sub-element of element 905.

After it has processed all sub-elements contained in element 305, it returns to step 802 to repeat the process for the next intended advertising unit that has been affected by the ad blocking plugin. When it has completed, new elements will have been created in proxy 705 (and therefore also in HTML document 702 and proxy 706) that are in similar to the original advertising, but which have no identifiable characteristics that identify them as advertising content that are accessible to the ad blocking plugin from its isolated world.

We claim:

1. A method for rendering a webpage within a browser environment, the webpage being formed from a plurality of code elements provided within a webpage document, the plurality of code elements comprising at least one element identifiable as a non-visible element, the non-visible elements being associated code instructions that when executed by a web browser result in the non-visible element not being displayed in the browser, the method comprising:
parsing code within the webpage document to identify at least one of the identifiable non-visible elements and
for each identified non-visible element, generating a version of that non-visible element, the version of that non-visible element being associated with code instructions that will allow a subsequent displaying of the version of the non-visible element within the webpage when executed by the web browser.

2. The method of claim 1 comprising rendering the webpage using the version of that non-visible element.

3. The method of claim 1 wherein the generating a version of that non-visible element comprises modifying code instructions associated with the non-visible element to subsequently allow for a displaying of that identified non-visible element.

4. The method of claim 1 wherein generating a version of that non-visible element comprises
generating a new code element in the webpage document; and
associating the new code element with the code instructions that will render a display of the version of the non-visible element within the webpage when executed by the web browser.

5. The method of claim 1 wherein the code elements comprises attributes.

6. The method of claim 1, wherein the code instructions associated with the non-visible element instructions are CSS instructions; and optionally CSS format instructions.

7. The method of claim 1 wherein an intended content associated with the non-visible element is retrieved by the browser from a remote server, if the element identifiable as a non-visible element is not present within the plurality of code element.

8. The method of claim 1 wherein the intended content associated with the non-visible element is stored within the mapping table within an isolated area wherein the ad blocking plugin remains unable to identify it.

9. The method of claim 1, wherein the webpage is a HTML document.

10. The method of claim 1, wherein identifying (802) at least one non-visible element comprises:
identifying one of more predetermined attributes associated with or defined by the code elements; and
using the predetermined attributes to identify the at least one non-visible element.

11. The method of claim 1, wherein generating a version of that non-visible element, comprises:
creating a new identifier;
storing the new identifier in a mapping table;
creating a new element in the webpage document; and
identifying a new attribute of the new element with the new identifier; and
wherein the new identifier is a random new element name.

12. The method of claim 1, wherein generating a version of that non-visible element comprises:
copying the code instructions; and
removing code instructions from the copied code instructions that when executed by a web browser result in the non-visible element not being displayed in the browser; and
wherein code instructions that when executed by a web browser result in the non-visible element not being displayed in the browser are originated in an ad-blocking plugin.

13. The method of claim 1, wherein generating a version of that non-visible element comprises:
modifying selectors referenced in the modified copied code instructions so that they refer to the new identifier; and
adding the modified copied code instructions to the web-page, so that the formatting of the new element is made to match that of the non-visible element; and
wherein the selectors were originally referenced to the attributes of the element identifiable as a non-visible element.

14. The method of claim 1 further comprising evaluating that the new element has an equivalent behaviour to the non-visible element; the evaluation comprising:
replacing JavaScript™ routines that were registered to respond to events on the non-visible element; or
registering new JavaScript™ routines on the new element to emulate the functionality of the attributes of non-visible element.

15. The method of claim 14 wherein replacing JavaScript™ routines that were registered to respond to events on the non-visible element comprises:
retrieving JavaScript™ routines registered to respond to events on the non-visible element; and
associating the retrieved routines to respond to events on the new element.

16. The method of claim 14 wherein registering new JavaScript™ routines on the new element to emulate the functionality of the attributes of non-visible element comprises:
checking for the presence of attributes on the non-visible element that provide functionality; and
registering new Javascript™ routines on the new element that emulate the functionality of the original attributes; and
wherein attributes that provide functionality causes the web browser to load a specific web page whenever the element upon which it is set is clicked.

17. A method for rendering a webpage within a browser environment comprising:
Parsing code within a webpage document to identify expected content within code elements of the webpage document; and
On determining the absence of expected content, providing within the webpage document code elements for that expected content;
Rendering the webpage based on the webpage document including the code elements for that expected content.

18. The method of claim 17 wherein providing code elements for that expected content comprises:
generating a new code element in the webpage document; and
associating the new code element with the code instructions that will render a display of the expected content within the webpage when executed by the web browser.
